(19) United States
(12) Patent Application Publication
(10) Pub. No.: US 2008/0300750 A1
(43) Pub. Date: Dec. 4, 2008

(54) CONTROL CHANNEL FOR VEHICLE SYSTEMS USING THE VEHICLE'S POWER DISTRIBUTION SYSTEM

(76) Inventors: Terry L. Davis, Issaquah, WA (US); Sudhakar Shetty, Mercer Island, WA (US); Roger C. VonDoenhoff, Federal Way, WA (US)

Correspondence Address: MOORE AND VAN ALLEN PLLC FOR BOEING, 430 DAVIS DRIVE, SUITE 500, MORRISVILLE, NC, 27560, US

(21) Appl. No.: 11/755,386

(22) Filed: May 30, 2007

(51) Int. Cl. G06F 7/00

(52) U.S. Cl. 701/36

(57) ABSTRACT

A control channel for controlling a system of a vehicle may include an electrical power distribution system for supplying electrical power to a plurality of different systems onboard the vehicle. The control channel may also include a first interface to convert a signal for controlling or communicating with a selected vehicle system of the plurality of different systems on board the vehicle into a format for insertion and transmission over a power line that also supplies electrical power to the selected vehicle system, wherein the power line forms a part of the electrical power distribution system of the vehicle. The control channel may also include a second interface to convert a signal received over the power line into a format for use by the selected vehicle system.

### BACKGROUND OF THE INVENTION

The present invention relates to vehicles, such as aircraft, aerospace vehicles and other vehicles, and controlling systems of such vehicles, and more particularly to a control channel for vehicle or aircraft systems using the vehicle's or aircraft's electrical power distribution system.

In controlling onboard aviation networked systems or other systems for operation of an aerospace vehicle, aircraft or other vehicle, a control channel for sending and receiving control signals, communications or other data is desired or in some applications may be required that is secure and not accessible via any offboard link. Separate wired control connections are one solution; however, the additional wiring can add significant weight to the aerospace vehicle and requires the installation of separate wiring for each system. The additional wiring also adds to the complexity of each of the systems increasing manufacturing, installation and maintenance costs. Reliability may also be reduced because of possible damage to or deterioration of the additional control wiring. A wireless solution while perhaps reducing some of the disadvantages of the wired solution has its own challenges and constraints due to spectrum and security risks.

### BRIEF SUMMARY OF THE INVENTION

In accordance with an embodiment of the present invention, a control channel for controlling a system of a vehicle may include an electrical power distribution system for supplying electrical power to a plurality of different systems onboard the vehicle. The control channel may also include a first interface to convert a signal for controlling or communicating with a selected vehicle system of the plurality of different systems on board the vehicle into a format for insertion and transmission over a power line that also supplies electrical power to the selected vehicle system, wherein the power line forms a part of the electrical power distribution system of the vehicle. The control channel may further include a second interface to convert a signal received over the power line into a format for use by the selected vehicle system.

In accordance with another embodiment of the present, a system for transmitting electrical power and communications over an aerospace vehicle's electrical power system may include a first interface to convert a signal for controlling or communicating with a selected aerospace vehicle system of a plurality of different systems on board the aerospace vehicle into a format for insertion and transmission over a power line that also supplies electrical power to the selected aerospace vehicle system, wherein the power line forms a part of the electrical power distribution system of the aerospace vehicle. The system may also include a second interface to convert a signal received over the power line into a format for use by the selected aerospace vehicle system.

In accordance with another embodiment of the present invention, an aerospace vehicle may include a plurality of vehicle systems for operation of the aerospace vehicle. The aerospace vehicle may also include an electrical power distribution system for supplying electrical power to each of the plurality of vehicle systems. The aerospace vehicle may further include a control channel associated with each vehicle system for controlling operation of each of the vehicle systems by sending control data signals to each of the vehicle systems over the electrical power distribution system that also supplies electrical power to each of the systems.

In accordance with another embodiment of the present invention, a method for transmitting electrical power and communications over an aerospace vehicle's electrical power system may include generating a signal for transmission to a selected aerospace vehicle system and converting the signal to a converted signal in a format for transmission over the aerospace vehicle's electrical power system. The method may also include inserting the converted signal on a power line of the electrical power system. The method may further include receiving the converted signal at the selected aerospace vehicle system via the power line.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block diagram of an example of a system for transmitting electrical power and communications over a vehicle's electrical power distribution system in accordance with an embodiment of the present invention.

FIGS. 2 is a flow chart of an example of a method for transmitting electrical power and communications over a vehicle's electrical power distribution system in accordance with an embodiment of the present invention.

FIG. 3 is an illustration of an aircraft including a system for transmitting electrical power and communications over an aircraft's electrical power distribution system in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

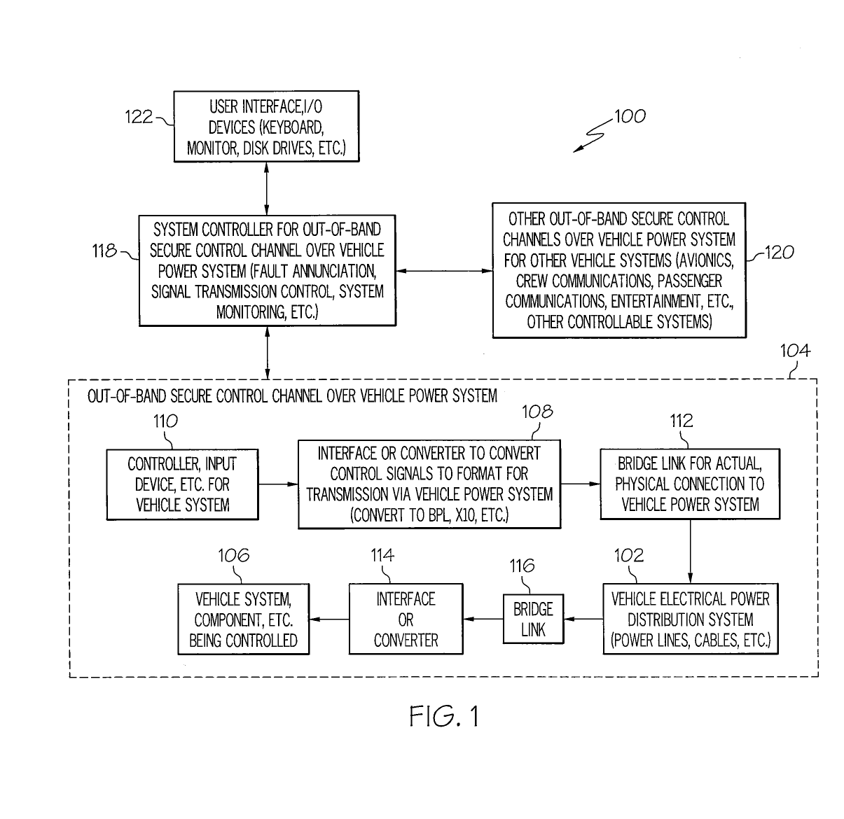

FIG. 1 is a block diagram of an example of a system 100 for transmitting electrical power and communications or data over a vehicle's electrical power distribution system 102 in accordance with an embodiment of the present invention. The system 100 may include a control channel 104 associated with each vehicle system 106 or each component of a vehicle system for controlling operation of the vehicle system or component by sending communications, control data signals or the like over the vehicle's electrical power distribution system 102. The control channel 104 may provide out-of-band secure communications over the electrical power distribution system 102. Out-of-band may denote a channel that is completely separate from the channel used by the system for normal data communications. As described herein, the vehicle may be an aerospace vehicle or aircraft; however, the system 100 for transmitting communications, control data signals or the like over the vehicle's electrical power distribution system 102 may also be any other type of vehicle, such as terrestrial vehicle, watercraft or the like.

The control channel 104 may include an interface 108, converter or other device to convert control signals, communication signals or other data into a format for transmission via the vehicle's electrical power distribution system 102. The interface 108 may convert Ethernet data signaling or signals into one of Broadband over Power Line (BPL) type signals or signaling, X10 type signals or signaling, symmetrical hi-broadband BPL, automotive-style low-bandwidth power line communications (PLC) type signals or signaling, or a similar type signaling or message protocol for sending control signals or data over an electrical power line that also supplies electrical power to a system.

The control channel interface 108 may receive communications, control signals or data from a controller 110, input device, or component of a vehicle system with which the interface 108 is associated. A bridging link 112 may be associated with the interface 108 to actually, physically connect the interface 108 to the vehicle power distribution system 102.

A second interface 114 or converter may be associated with the vehicle system 106 or component of the vehicle system being controlled to convert the control signal received over a power line of the vehicle distribution system 102 to a format for use by the selected vehicle system 106 or component. Another bridging link 116 associated with the interface 114 may make the actual physical connection to the power line of the vehicle power distribution system 102.

In another embodiment of the present invention, the interfaces 108 and 114 may each be a bidirectional or two-way interface or converter that may be associated with each component of a vehicle system. The bidirectional interface may both convert signals to a format for insertion and transmission over the electrical power distribution system 102 and also convert signals received over the electrical power distribution system 102 to a format for use by the vehicle system 106 or component.

The interface 114 or bidirectional interface may be embedded in a power converter associated with each individual vehicle system 106 or system component.

The system 100 may also include an overall or master system controller 118 for out-of-band secure control channel communications via the vehicle's electrical power distribution system 102. The system controller 118 may perform functions including but not necessarily limited to fault detection and annunciation, signal transmission control, for example, stopping and starting data transmission, system monitoring and any other functions that may be appropriate for monitoring and controlling data or controlling communications over the electrical power system 102. The system controller 118 may control other out-of-band secure control channels 120 for other vehicle systems, such as avionics, passenger communications, and passenger entertainment and any other system that may need controlling.

The system 100 may also include a user interface 122. The user interface 122 may include input and output devices, such as a keyboard, monitor, disk drives and the like to permit a user to manage and maintain the system 100.

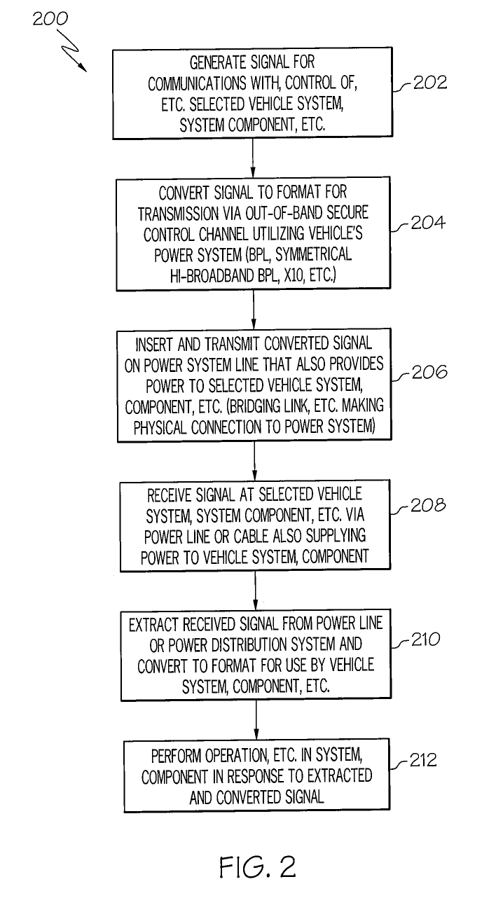

FIGS. 2 is a flow chart of an example of a method 200 for transmitting electrical power and communications over a vehicle's electrical power distribution system in accordance with an embodiment of the present invention. The method 200 may be embodied in the system 100 of FIG. 1. In block or module 202, a signal may be generated for communication with or control of a selected vehicle system or component of the selected vehicle system.

In block or module 204, the signal may be converted to a format for transmission via an out-of-band secure control channel or as an out-of-band secure signal over the vehicle's electrical power distribution system. Similar to that previously described, the control signal or Ethernet data may be converted to BPL, symmetrical hi-broadband BPL, X10, automotive-style PLC or similar type signals or protocol for secure out-of-band transmission over the power distribution system of the vehicle.

In block 206, the converted signal may be inserted and transmitted on a power line or cable that also provides power to the selected vehicle system or component. A bridging link may make the actual physical connection to the power line or cable as previously described.

In block or module 208, the signal may be received at the selected system or system component via the power line or cable that is also supplying electrical power to the system or system component.

In block 210, the received signal may be extracted from the power line of the power distribution system and converted to a format for use by the vehicle system or component. The received signal may be converted back to Ethernet data or other signal from the BPL, symmetrical hi-broadband BPL, X10, automotive-style PLC or similar type signal.

In block 212, the operation or function may be performed by the selected vehicle system or system component in response to the extracted and converted signal.

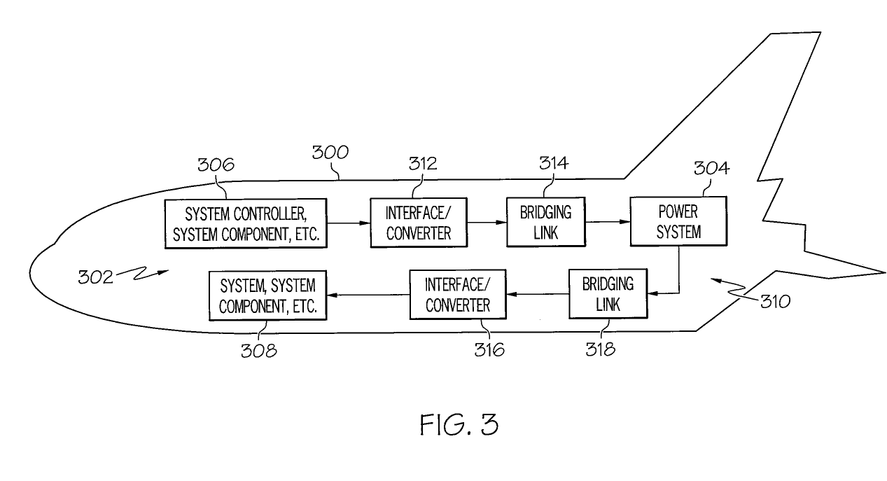

FIG. 3 is an illustration of an aircraft 300 including a system 302 for transmitting electrical power and communications or data over an aircraft's electrical power distribution system 304 in accordance with an embodiment of the present invention. The system 302 may be similar to the system 100 of FIG. 1 and may embody the method 200 of FIG. 2. The system 302 may include a system controller 306 to generate signals for controlling operation of a selected aircraft system 308 via a control channel 310. In another embodiment of the present invention, the blocks 306 and 308 may be different components of an aircraft system that may communicate with one another via the control channel 310.

The control channel 310 may be an out-of-band secure control channel that operates at frequencies that prevent access via any links or means not associated with the aircraft 300. This prevents any unauthorized or inadvertent access to the aircraft's vital systems and provides a highly secure and reliable system in aircraft and airport environments. Whereas wireless gatelink services or similar wireless services may vary with the amount of radio frequency (RF) interference within the aircraft and wired solutions add weight and manufacturing complexity and cost.

The control channel 310 may include an interface 312 or converter to convert the communications signals or Ethernet data to a format for insertion and communications over the aircraft's electrical power system 304 similar to that previously described. A bridging link 314 may make the actual connection to the power line or cable of the power system 304.

A second interface 316 may be associated with the aircraft system 308 or component of the aircraft system 308. The second interface 316 may convert signals received from the aircraft power system 304 to a format for use by the aircraft system 308 or system component. A second bridging line 318 may couple the second or receiving interface 318 to the power line or cable of the aircraft's power system 304.

In accordance with an embodiment of the present invention, the interfaces 312 and 316 may each be bidirectional or two-way interfaces that may each be associated with a component of a selected vehicle system for bidirectional or two-way communications or data transfer between the components (blocks 306 and 308). The bidirectional interfaces may both convert signals to a format for insertion and transmission over the electrical power distribution system 304 of the aircraft and also convert signals received over the electrical power distribution system 304 for use by the system components. Similar to that previously described, the interfaces 312 and 316 may be adapted to convert signals to and from, hi-broadband BPL, X10, or automotive-style PLC type signals. With hi-broadband BPL, the potential exists, especially in limited distances, to reach communication speeds for aircraft applications above 200 megabits per second, which exceeds bandwidth requirements of out-of-band applications. Accordingly, the system 302 of the embodiment of the present invention will be highly secure and reliable in aircraft and airport environments. Whereas wireless gatelink services and similar communications means vary with the amount of radio frequency (RF) interference within the aircraft and wired solutions add weight and manufacturing complexity of the aircraft 300.

If the aircraft 300 is a passenger aircraft, the power distribution system 304 may supply electrical power and voice and data communications to each passenger seat. A first and second interface 312 and 316 or a bidirectional interface may be associated with each passenger seat for data and voice communications over the aircraft's power distribution system 304.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A control channel for controlling a system of a vehicle, comprising:
an electrical power distribution system for supplying electrical power to a plurality of different systems onboard the vehicle;
a first interface to convert a signal for controlling or communicating with a selected vehicle system of the plurality of different systems on board the vehicle into a format for insertion and transmission over a power line that also supplies electrical power to the selected vehicle system, wherein the power line forms a part of the electrical power distribution system of the vehicle; and
a second interface to convert a signal received over the power line into a format for use by the selected vehicle system.

2. The control channel of claim 1, wherein the first interface is associated with a first component of the selected vehicle system and the second interface is associated with a second component of the selected vehicle system to permit communications between the first and second components of the selected vehicle system over the electrical power distribution system of the vehicle that also supplies electrical power to each of the components.

3. The control channel of claim 1, wherein the first interface and the second interface form a single bidirectional interface and wherein the control channel further comprises a bidirectional interface associated with each component of the selected vehicle system, wherein the bidirectional interface is adapted to both convert signals to a format for insertion and transmission over the electrical power distribution system of the vehicle and to convert signals received over the electrical power distribution system of the vehicle for use by the component of the selected vehicle system.

4. The control channel of claim 1, wherein the electrical power distribution system simultaneously supplies electrical power and control or communications signaling to the selected vehicle system.

5. The control channel of claim 1, wherein the electrical power distribution system simultaneously supplies electrical power and control or communications signaling between components of the selected vehicle system.

6. The control channel of claim 1, further comprising a bridging link associated with each interface to physically connect each interface to the electrical power distribution system.

7. The control channel of claim 1, wherein each of the first and second interfaces are adapted for out-of-band secure signaling over the electrical power distribution system.

8. The control channel of claim 1, further comprising a controller to control transmission of data over the electrical power distribution system.

9. The control channel of claim 1, wherein the first interface converts Ethernet data signals into one of BPL, X10, PLC and symmetrical hi-broadband BPL type signals for insertion into the electrical power distribution system, and wherein the second interface converts the BPL, X10, PLC or symmetrical hi-broadband BPL types signals from the vehicle's electrical power distribution system into Ethernet data signals for use by the selected vehicle system.

10. The control channel of claim 1, wherein the first and second interfaces are each respectively adapted to convert Ethernet data signaling into one of BPL type signaling, X10 type signaling, automotive-style PLC and symmetrical hi-broadband BPL type signaling for insertion into the electrical power distribution system, and to convert the BPL, X10, automotive-style PLC or symmetrical hi-broadband BPL type signaling from the power distribution system into Ethernet data signaling for use by an associated component of the selected vehicle system.

11. A system for transmitting electrical power and communications over an aerospace vehicle's electrical power system, comprising:
a first interface to convert a signal for controlling or communicating with a selected aerospace vehicle system of a plurality of different systems on board the aerospace vehicle into a format for insertion and transmission over a power line that also supplies electrical power to the selected aerospace vehicle system, wherein the power line forms a part of the electrical power distribution system of the aerospace vehicle; and
a second interface to convert a signal received over the power line into a format for use by the selected aerospace vehicle system.

12. The system of claim 11, wherein the first interface and the second interface are combined in a single bidirectional interface and wherein the system further comprises a bidirectional interface associated with each component of the selected aerospace vehicle system, wherein the bidirectional interface is adapted to both convert signals to a format for insertion and transmission over the electrical power distribution system of the aerospace vehicle and to convert signals received over the electrical power distribution system of the aerospace vehicle for use by the component of the selected aerospace vehicle system.

13. The system of claim 11, wherein the aerospace vehicle is a passenger aircraft and wherein the power distribution system supplies electrical power and out-of-band secure communications to each passenger seat.

14. The system of claim 11, wherein the each of the first and second interfaces are adapted for out-of-band secure signaling over the electrical power distribution system.

15. The system of claim 11, wherein the aerospace vehicle is a passenger aircraft and further comprising a first and second interface associated with each passenger seat for at least one of data and voice communications over the electrical power distribution system of the passenger aircraft.

16. The system of claim 11, further comprising a bridging link associated with each interface to physically connect each interface to the electrical power distribution system.

17. The system of claim 11, further comprising a controller to control transmission of communications or data over the electrical power distribution system.

18. The system of claim 17, wherein the controller comprises a fault annunciation circuit, a signal transmission control circuit, a signal monitoring circuit, and an output device to present system's control data.

19. An aerospace vehicle, comprising:
a plurality of vehicle systems for operation of the aerospace vehicle;
an electrical power distribution system for supplying electrical power to each of the plurality of vehicle systems; and
a control channel associated with each vehicle system for controlling operation of each of the vehicle systems by sending control data signals to each of the vehicle systems over the electrical power distribution system that also supplies electrical power to each of the systems.

20. The aerospace vehicle of claim 19, wherein the control channel is adapted for out-of-band secure communications over the electrical power distribution system of the aerospace vehicle.

21. The aerospace vehicle of claim 19, wherein each control channel comprises an interface to convert a signal for controlling or communicating with the associated aerospace vehicle system of the plurality of systems on board the aerospace vehicle into a format for insertion and transmission over a power line that also supplies electrical power to the associated aerospace vehicle system, wherein the power line forms a part of the electrical power distribution system of the aerospace vehicle.

22. The aerospace vehicle of claim 21, wherein each control channel further comprises a second interface to convert a signal received over the power line into a format for use by the selected aerospace vehicle system.

23. The aerospace vehicle of claim 21, further comprising a bridging link associated with each interface to physically connect each interface to the electrical power distribution system of the aerospace vehicle.

24. The aerospace vehicle of claim 19, wherein each control channel comprises an interface to at one of convert Ethernet data signaling into one of BPL type signaling, X10 type signaling, automotive-style PLC type signaling and symmetrical hi-broadband BPL type signaling for insertion into the electrical power distribution system, and convert the BPL, X10, PLC or symmetrical hi-broadband BPL type signaling from the electrical power distribution system into Ethernet data signaling for use by the associated vehicle system.

25. A method for transmitting electrical power and communications over an aerospace vehicle's power system, comprising:
generating a signal for transmission to a selected aerospace vehicle system;
converting the signal to a converted signal in a format for transmission over the aerospace vehicle's electrical power system;
inserting the converted signal on a power line of the electrical power system; and
receiving the converted signal at the selected aerospace vehicle system via the power line.

26. The method of claim 25, further comprising:
extracting the received signal from the power line at the selected aerospace vehicle system; and
converting the received signal to another format for use by the aerospace vehicle system.

27. The method of claim 25, further comprising supplying communications and electrical power to each passenger seat in the aerospace vehicle over the aerospace vehicle's electrical power system.

28. The method of claim 25, wherein converting the signal to a converted signal in a format for transmission over the aerospace vehicle's electrical power system comprises converting the signal for out-of band secure communications.

29. The method of claim 25, wherein converting the signal to a converted signal in a format for transmission over the aerospace vehicle's electrical power system comprises converting the signal to one of a BPL type signal, an X10 type signal, an automotive-style PLC type signal and a hi-broadband BPL type signal.
